(19) United States
(12) Patent Application Publication
(10) Pub. No.: US 2026/0287985 A1
(43) Pub. Date: Sep. 24, 2026

(54) IMAGING APPARATUS

(71) Applicant: ARASHI VISION INC., Shenzhen (CN)

(72) Inventors: Guang WU, Shenzhen (CN); Qijiang WU, Shenzhen (CN); Xuange PENG, Shenzhen (CN)

(73) Assignee: ARASHI VISION INC., Shenzhen (CN)

(21) Appl. No.: 19/573,228

(22) Filed: Mar. 20, 2026

(30) Foreign Application Priority Data
Mar. 21, 2025 (CN) 202520508565.4

(51) Int. Cl. G03B 17/56; G03B 31/00; H04N 23/51; H04N 23/63; H04N 23/698

(52) U.S. Cl. CPC G03B 17/566; G03B 17/561; G03B 31/00; H04N 23/51; H04N 23/63; H04N 23/698

(57) ABSTRACT

An imaging apparatus includes a first face; a second face arranged parallel to the first face; a lens, arranged at a first end of the imaging apparatus on at least one of the first face or the second face, and protruding at least partially from the first face and/or the second face; and a side face, connecting the first face and the second face. At least two of the side faces are respectively provided with at least one first interface configured to mount a first accessory and at least one second interface configured to mount a second accessory different from the first accessory.

### CROSS-REFERENCE TO RELATED APPLICATION

This application claims the benefit of priority to Chinese Patent Application No. 202520508565.4, filed on Mar. 21, 2025, the entire content of which is hereby incorporated by reference in its entirety.

### BACKGROUND

The present disclosure relates to the technical field of imaging, and more specifically, to an imaging apparatus.

Currently, panoramic cameras generally have flat curved surfaces or flat surfaces on their exterior faces, which can cause some problems in certain accessory usage scenarios.

For example, when the accessory is a lens silicone protector, due to the lack of a limiting structure around the lens, in order to ensure ease of assembly and disassembly, the silicone protector is often made with a certain angle. When the protector is fitted onto the camera, the clamping force provided by the inner angle of the silicone protector is configured to fix. However, if the clamping force is too large, it becomes difficult to fit the silicone protector onto the camera during use. If the clamping force is too small, the silicone protector is easily loosened after assembly, and when taking the camera with the silicone protector out of a pocket or bag, the silicone protector easily falls off.

For example, when the accessory is a noise reduction windproof cotton, in order to ensure the sound recording effect of the camera, multiple microphones are generally arranged on multiple faces of the camera. However, in some high-speed movement scenarios, such as riding a motorcycle, the wind speed is high. To reduce the impact of wind noise, it is necessary to provide noise reduction windproof cotton for use. However, there is no positioning structure around the microphone opening position. The current solution mostly uses double-sided adhesive to stick the noise reduction windproof cotton onto the microphone opening that needs wind noise reduction, which results in a lack of positioning, adhesive position deviation, and certain interference when used with other accessories.

Therefore, there is a need to provide an imaging apparatus that allows for easy assembly and disassembly of accessories and easy compatibility with various accessories.

### SUMMARY

According to one aspect of the present disclosure, an imaging apparatus is provided. The imaging apparatus includes a first face; a second face arranged parallel to the first face; at least one lens, arranged at a first end of the imaging apparatus on at least one of the first face or the second face, and protruding at least partially from at least one of the first face or the second face; and at least one side face, connecting the first face and the second face. At least two of the at least one side face are respectively provided with at least one first interface configured to mount a first accessory and at least one second interface configured to mount a second accessory different from the first accessory.

In one implementation, the imaging apparatus further includes a display screen, arranged at a second end of the imaging apparatus opposite to the first end, on at least one of the first face or the second face.

In one implementation, the at least one lens includes a first lens and a second lens, respectively arranged on the first face and the second face, where the central planes of the first lens and the second lens are located on the same plane.

In one implementation, the at least one side face includes a first side face and a second side face, the first side face and the second side face are arranged parallel to each other. where the first side face and the second side face are respectively provided with at least one first interface.

In one implementation, the at least one first interface respectively arranged on the first side face and the second side face satisfies at least one of the following conditions:

the at least one first interface respectively arranged on the first side face and the second side face are arranged symmetrically;

the types of the at least one first interface respectively arranged on the first side face and the second side face are the same;

the sizes of the at least one first interface respectively arranged on the first side face and the second side face are the same;

the shapes of the at least one first interface respectively arranged on the first side face and the second side face are the same; or

the numbers of the at least one first interface respectively arranged on the first side face and the second side face are the same.

In one implementation, the at least one first interface respectively arranged on the first side face and the second side face are arranged symmetrically, and the geometric centers of the at least one first interface on the first side face and the second side face are both on the central plane.

In one implementation, the at least one side face further includes a top face and a bottom face arranged parallel to each other, and the top surface and the bottom surface extend in a vertical direction of the first side face and the second side face.

In one implementation, the bottom face is located at the second end of the imaging apparatus, and at least one second interface is provided on the bottom face.

In one implementation, at least one first interface is provided on the top face.

In one implementation, the at least one first interface satisfies at least one of the following conditions:

the at least one first interface is configured as a recess;

the at least one first interface is configured as a protrusion;

the at least one first interface is provided with a magnetic member; or

a magnetic sensing member is provided inside the at least one first interface.

In one implementation, the at least one second interface satisfies at least one of the following conditions:

the at least one second interface is configured to be threadedly connected with the second accessory;

the at least one second interface is configured to be buckle-connected with the second accessory; or

the at least one second interface is configured to be magnetically connected with the second accessory.

In one implementation, when the first accessory is mounted on the at least one first interface, it covers one end of the imaging apparatus.

In one implementation, the first accessory is provided with a fastening member on the side facing the at least one first interface, which cooperates with the at least one first interface.

In one implementation, the first accessory includes at least one of a protective element, a noise reduction element, a lighting device, a sound receiving device, a sound playback device, or a display device.

In one implementation, the imaging apparatus further includes at least one microphone hole, the first accessory includes a noise reduction element, and the noise reduction element is mounted on the first interface and is configured to cover the at least one microphone hole.

In one implementation, the second accessory includes at least one of a selfie stick, a magnetic adapter, a tripod, or a stabilizer.

### BRIEF DESCRIPTION OF DRAWINGS

The drawings incorporated herein and forming a part of the specification illustrate the present disclosure and, together with the description, further serve to explain the principles of the present disclosure and enable those skilled in the art to make and use the implementations described herein.

FIG. 1 is a perspective schematic diagram of an imaging apparatus, according to some embodiments of the present disclosure.

FIG. 2 is a perspective schematic diagram of a noise reduction element, according to some embodiments of the present disclosure.

FIG. 3 is a perspective schematic diagram of an imaging apparatus with a noise reduction element installed, according to some embodiments of the present disclosure.

FIG. 4 is a front schematic diagram of a noise reduction element, according to some embodiments of the present disclosure.

FIG. 5 is a perspective schematic diagram of a protective element, according to some embodiments of the present disclosure.

FIG. 6 is a perspective schematic diagram of an imaging apparatus with a protective element installed, according to some embodiments of the present disclosure.

FIG. 7 is a sectional schematic diagram of a protective element, according to some embodiments of the present disclosure.

FIG. 8 is a top schematic diagram of an imaging apparatus, according to some embodiments of the present disclosure.

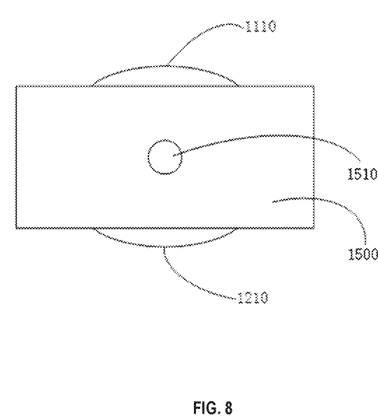

FIG. 9 is a schematic diagram of the direction of force applied to a fastening member of a first accessory inserted into a recess, according to some embodiments of the present disclosure.

The features of the present disclosure will become more apparent in the following detailed description in conjunction with the drawings, in which like reference numerals always identify corresponding elements. In the drawings, like reference numerals generally indicate the same, functionally similar, and/or structurally similar elements. Unless otherwise indicated, the drawings provided throughout the application should not be construed as drawings drawn to scale.

### DETAILED DESCRIPTION

The following provides a description of the present disclosure in conjunction with specific implementations and with reference to the drawings.

However, it should be understood that these descriptions are merely exemplary and are not intended to limit the scope of the present disclosure. In the following detailed description, for the purpose of explanation, many specific details are set forth to provide a comprehensive understanding of the implementations of the present disclosure. However, it is obvious that one or more implementations can be implemented without these specific details. In addition, in the following description, descriptions of well-known technologies are omitted to avoid unnecessarily obscuring the concepts of the present disclosure.

The terminology used herein is only for the purpose of describing specific implementations and is not intended to limit the present disclosure. The term “include” as used herein indicates the presence of features, operations, or actions, but does not preclude the presence or addition of one or more other features.

The expressions “first,” “second,” “third,” “fourth,” etc., appearing herein are only used for descriptive purposes, such as distinguishing different components, and should not be construed as indicating or implying relative importance or implicitly indicating the number of technical features referred to. Features designated as “first,” “second” may expressly or implicitly include at least one feature. In the description of the present disclosure, if the term “multiple” appears, “multiple” means at least two, such as two, three, etc., unless otherwise specifically limited.

In the present disclosure, unless otherwise expressly specified and limited, if the terms “mount,” “connect,” “couple,” “fix,” etc., appear, these terms should be understood broadly. For example, it can be a fixed connection, a detachable connection, or an integral connection; it can be a mechanical connection or an electrical connection; it can be a direct connection or an indirect connection through an intermediate medium; and it can be communication inside two elements or an interaction relationship between two elements, unless otherwise expressly limited. For those skilled in the art, the specific meanings of the above terms in the present disclosure can be understood according to the specific context.

In the present disclosure, unless otherwise expressly specified and limited, if there is a description such as the first feature being “on” or “under” the second feature, the meaning can be that the first and second features are in direct contact, or the first and second features are in indirect contact through an intermediate medium. Furthermore, the first feature being “above,” “on top of,” or “over” the second feature can mean that the first feature is directly above or obliquely above the second feature, or simply that the first feature is at a higher horizontal level than the second feature. The first feature being “below,” “under,” or “beneath” the second feature can mean that the first feature is directly below or obliquely below the second feature, or simply that the first feature is at a lower horizontal level than the second feature. The expressions “above,” “below,” etc., used in the present disclosure describe relative positions and are not absolute concepts, for example, they are used to describe the relative positions of several features in conjunction with the drawings.

All terms (including technical and scientific terms) used herein have the meanings commonly understood by those skilled in the art, unless otherwise defined. It should be noted that the terms used herein should be interpreted as having meanings consistent with the context of this specification, and should not be interpreted in an idealized or overly rigid manner.

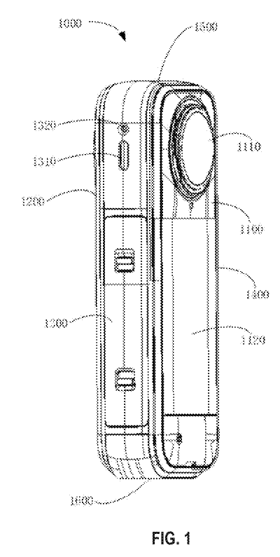

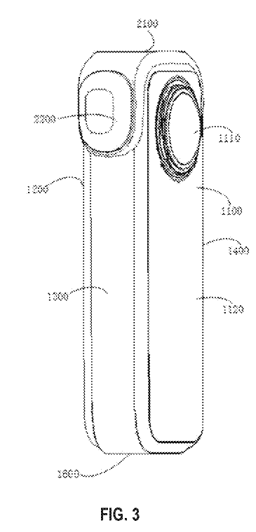

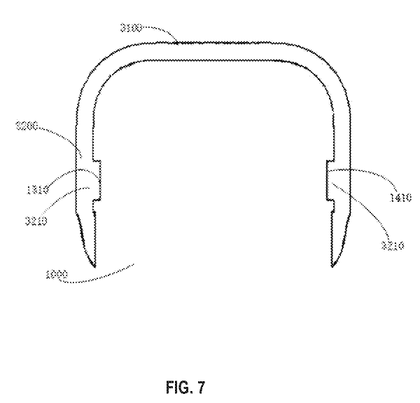

Referring to FIGS. 1 to 7, the present disclosure discloses an imaging apparatus 1000 according to some embodiments of the present disclosure. The imaging apparatus 1000 includes a panoramic camera and any other suitable type of camera and image acquisition apparatus. The imaging apparatus 1000 has, for example, a cuboid structure. In other implementations of the present disclosure, the imaging apparatus 1000 can have other shapes, such as a cylinder, an ellipsoid, a combination of two cuboids of different sizes, and other three-dimensional shapes with multiple surfaces. In one implementation, the imaging apparatus 1000 includes: a lens 1110, a first interface 1310, and a second interface. The imaging apparatus 1000 can also include other devices, such as a microphone hole 1320 shown in FIG. 1. The imaging apparatus 1000 shown in FIG. 1 is a hexahedral shape as an exemplary implementation. For convenience of description, the six faces (or surfaces) of the imaging apparatus 1000 are respectively referred to as a first face 1100, a second face 1200 arranged parallel to the first face 1100 (only one edge of the second face 1200 is shown in FIGS. 1, 3, and 6), and four side faces 1300, 1400, 1500, 1600 connecting the first face 1100 and the second face 1200 (only one edge of the side faces 1400, 1600 is shown in FIGS. 1, 3, and 6). The side faces 1300, 1400, 1500, 1600 can be sequentially referred to as: a first side face 1300, a second side face 1400, a third side face or top face 1500, and a fourth side face or bottom face 1600. The first side face 1300 and the second side face 1400 can be arranged parallel to each other, and the top face 1500 and the bottom face 1600 can be arranged parallel to each other. It should be understood that the imaging apparatus 1000 shown in FIG. 1 may not necessarily include the microphone hole 1320.

In the implementation of FIG. 1, the lens 1110 is arranged on the first face 1100 of the imaging apparatus 1000. FIG. 1 shows the lens 1110 located at a first end (the upper end as shown in the figure) of the imaging apparatus 1000. The lens 1110 can be a fisheye lens and protrudes at least partially from the first face 1100 and/or the second face 1200, thereby enabling wide-angle capturing of more than 180 degrees.

In another implementation, a lens 1110 is arranged on the first face 1100, and a lens 1110 is also arranged on the second face 1200. The combination of the two lenses allows the imaging apparatus 1000 to achieve 360-degree capturing without blind spots. Through software, the images captured by the two lenses can be combined into a panoramic image. The central planes of the lens arranged on the first face 1100 and the lens arranged on the second face 1200 are located on the same plane, such as a horizontal plane, so that when the imaging apparatus 1000 (for example, supported by the second interface) is configured to capture, the capturing heights of the lens arranged on the first face 1100 and the lens arranged on the second face 1200 are the same. In one implementation, the geometric centers of the lens on the first face 1100 and the lens on the second face 1200 are located on the same projection path.

In another implementation, the central planes of the lens on the first face 1100 and the lens on the second face 1200 are located on the same horizontal plane. However, unlike the previous implementation, the geometric centers of the two lenses are offset by a predetermined distance on the horizontal plane. In this implementation, the width of the first face of the imaging apparatus 1000 is larger than that shown in FIG. 1, the lens 1110 arranged on the first face 1100 is located near the side edge of the first face 1100, and the lens 1110 arranged on the second face 1200 is located near the side edge of the second face 1200. The two lenses are offset by a predetermined distance on the horizontal plane.

In one implementation, the imaging apparatus 1000 can also include a display screen 1120. The display screen 1120 is arranged on at least one of the first face 1100 or the second face 1200 of the imaging apparatus 1000 and is located at a second end (the second end is the end opposite to the first end, that is, the lower end as shown in the figure). It should be understood that the lens 1110 is located at the first end, and the display screen 1120 is located at the second end. This does not strictly limit the display screen 1120 to be arranged only near the second end and not beyond the middle position of the imaging apparatus 1000. It can be understood that the lens 1110 and the display screen 1120 are both arranged on the first face of the imaging apparatus 1000 (as shown in FIG. 1), where the lens 1110 is closer to the first end of the imaging apparatus 1000, and the display screen 1120 is closer to the second end of the imaging apparatus 1000. In another implementation, a lens and a display screen are arranged on the second face 1200, and the layout of the lens and the display screen can be the same as or different from that on the first face 1100. For example, the display screen can have different sizes and/or types. The display screen 1120 can display information of interest to the user, such as power-on and power-off information, battery level information, time information, etc., and can also display images captured by the imaging apparatus 1000. The display screen 1120 can be an LCD display screen, an OLED screen, a touch screen, or other suitable display screens.

In one implementation, the imaging apparatus 1000 includes a first interface 1310 and a second interface. The first interface is configured to connect a first accessory, and the first accessory is configured to improve the performance of the imaging apparatus in capturing images/videos. The second interface is configured to connect a second accessory, and the second accessory is configured to expand the usage scenarios of the imaging apparatus. For example, referring to FIG. 1, the first interface 1310 is arranged on the first side face 1300, and the second interface (not shown in FIG. 1) is arranged on the bottom face 1600. The first interface 1310 is configured to connect the first accessory to improve the performance of the imaging apparatus 1000 in capturing images/videos and/or to provide protection for the imaging apparatus 1000. For example, the first accessory can be a lens protector. When the first accessory is mounted to the imaging apparatus 1000 via the first interface 1310, it can protect the lens of the imaging apparatus 1000. The second interface is configured to connect the second accessory to expand the usage scenarios of the imaging apparatus 1000. For example, the second accessory is a support base or a gimbal, and can also be configured to extend a selfie stick of the imaging apparatus 1000, a tripod for holding and supporting the imaging apparatus, a stabilizer, etc. For example, the second interface is used to connect a support base, allowing the screw of the support base to be threadedly engaged with the second interface, thereby fixing and supporting the imaging apparatus on the support base. The first accessory and the second accessory can be accessories with different functions, and the first interface 1310 and the second interface can be interfaces with different structures. In this implementation, the first interface 1310 is arranged at the first end of the imaging apparatus 1000, and the second interface is arranged at the second end of the imaging apparatus 1000. The imaging apparatus 1000 is fixedly connected to, for example, a support frame or an extension rod via the second interface, so that it can move with a vehicle or an Unmanned Aerial Vehicle (UAV), while allowing the first interface 1310 to be mounted with a lighting device, a noise reduction element, a sound playback device, a protective element, etc. The first interface 1310 allows the first accessory to be inserted and removed at will, so that new first accessories can be freely replaced, enabling the imaging apparatus 1000 to be freely matched with various first accessories with different functions. The replacement process is convenient and simple, improving the user experience. Various implementations of the first interface 1310 are described below.

In one implementation, as shown in FIG. 1, the first interface 1310 of the imaging apparatus 1000 can be a recess, arranged on the first side face 1300. The first interface 1310 extends a certain depth from the first side face 1300 toward the inside of the imaging apparatus 1000. The sidewall of the first interface 1310 forms a 90-degree angle with the first side face 1300. In other words, the sidewall of the first interface 1310 extends substantially in a direction perpendicular to the first side face 1300. The first interface 1310 can be an elongated recess with arc-shaped ends, as shown in FIG. 1, with its longitudinal axis in the vertical direction (e.g., a length direction of the imaging apparatus 1000 shown in FIG. 1). In another implementation, the longitudinal axis of the first interface 1310 is in the horizontal direction (e.g., a depth direction of the imaging apparatus 1000 shown in FIG. 1). The first interface 1310 can also be a recess of other shapes, such as rectangular, elliptical, pentagonal, hexagonal, or other polygonal holes. The first interface 1310 can be substantially arranged on the centerline of the first side face 1300. In one implementation, the geometric center of the first interface 1310 can be substantially aligned with the geometric center of the lens 1110 on the first face 1100. In one implementation, the geometric center of the first interface 1310 can be located below the geometric center (or central plane) of the lens 1110 on the first face 1100, that is, closer to the second end of the imaging apparatus 1000.

For example, in one implementation, the first accessory is, for example, a camera cap. When the imaging apparatus is not in use, the camera cap is connected to the first end of the imaging apparatus 1000. A fastening member provided on the inner side of one side of the camera cap is inserted into the first interface 1310, so that the fastening member is restricted by the first interface 1310. In this implementation, the arrangement and positioning of the first interface 1310 allow, during the process of fitting the camera cap onto the first end of the imaging apparatus 1000, when the fastening member on one side of the camera cap is inserted into the first interface 1310, for confirmation that the camera cap is fitted in place. At this time, the first interface 1310 serves as a positioning member. After the camera cap is fitted onto the first end of the imaging apparatus 1000, the first interface 1310 can restrict the displacement of the fastening member, thereby preventing the camera cap from shifting or even slipping off the imaging apparatus 1000 during movement or carrying. At this time, the first interface 1310 can improve the stability of the connection. Thus, the camera cap can be easily fitted onto the first end of the imaging apparatus 1000 provided with the first interface 1310. As the side of the camera cap elastically deforms, the fastening member can slide on the first side face 1300 of the imaging apparatus 1000 and snap into the first interface 1310, making a “click” sound, so that the user can confirm that the camera cap is fitted in place. When removing the camera cap, the user can remove the fastening member from the first interface 1310 with a little force, thus removing the camera cap, without requiring more actions. Accordingly, the user experience of using (including mounting, dismounting, and carrying) the camera cap can be improved.

In this implementation, the geometric center of the first interface 1310 can be located at or near the central plane of the lens 1110, or below the horizontal plane of the geometric center of the lens 1110. In the case where the first accessory is a camera cap, during the process of fitting the camera cap onto the first end of the imaging apparatus 1000, when the fastening member on the side of the camera cap snaps into the first interface 1310, the portion of the camera cap covering the lens 1110 faces the portion of the first face covering the lens 1110. The distance from the first interface 1310 to the imaging apparatus 1000 is close to the length of the side of the camera cap.

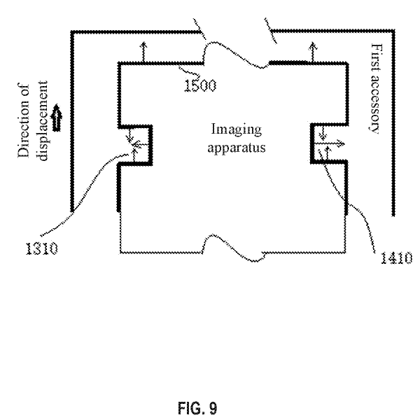

The structure and design of a specific example of the recess of the first interface 1310 are described below. FIG. 9 schematically shows a cross-section of the recess, in which the fastening member of the first accessory is schematically shown as being in close fit with the sidewall of the recess. However, according to the implementations of the present disclosure, this is not necessary. In other implementations of the present disclosure, the fastening member of the first accessory can be any shape of solid that can be inserted into the first interface 1310 or 1410. When the fastening member of the first accessory is fitted into the first interface 1310, the fastening member abuts against the sidewall of the first interface 1310. The sidewall applies a supporting force toward the fastening member in a direction perpendicular to the sidewall, thereby preventing movement of the first accessory in this direction. The sidewall of the first interface 1310 includes four portions extending in the horizontal direction in FIG. 9. The first portion of the sidewall is located on the upper side of the first interface 1310 and provides a downward supporting force (toward the second end of the imaging apparatus 1000), so that upward displacement of the first accessory is prevented. The second portion of the sidewall is located on the left side of the first interface 1310 and provides a rightward supporting force, so that leftward displacement of the first accessory is prevented. The third portion of the sidewall is located on the right side of the first interface 1310 and provides a leftward supporting force, so that rightward displacement of the first accessory is prevented. The fourth portion of the sidewall is located on the lower side of the first interface 1310 and provides an upward supporting force, so that downward displacement of the first accessory is prevented. In addition, the bottom surface of the first interface 1310 provides a supporting force toward the outside of the first interface 1310. However, the fastening member does not necessarily abut against the bottom surface of the first interface 1310. Due to the arrangement of the first interface 1310, after the fastening member of the first accessory is fitted into the first interface 1310, the displacement of the fastening member in the four directions (front, back, left, and right) is restricted, thereby providing an improved limiting effect for the first accessory. According to the implementations of the present disclosure, another advantage of the first interface 1310 is that the shape of the fastening member does not have to strictly match the first interface 1310. As long as the fastening member can enter the first interface 1310 when the first accessory is mounted to the first end of the imaging apparatus 1000 and contact one of the four portions (i.e., first, second, third and fourth portions) of the sidewall of the first interface 1310, for example, the first portion of the sidewall can restrict the displacement of the first accessory in the direction away from the imaging apparatus 1000. Therefore, the first interface 1310 has good adaptability; it does not have to have an inherent shape and is not constrained by the specific shape of the fastening member of a particular type of first accessory, which allows it to achieve both positioning and restricting displacement for the first accessory.

FIG. 9 also schematically shows the force applied by a recess form of the first interface 1310, 1410 to the fastening member, according to some embodiments, to understand the mechanical principle by which the first interface 1310, 1410 achieves good fixing of the first accessory. In the present disclosure, since the fastening member can have any shape, the specific shape of the fastening member is not illustrated in FIG. 9.

As schematically shown in FIG. 9, when the first accessory is fitted onto the imaging apparatus 1000, the inner side (or surface) of the upper side of the first accessory abuts against the top face 1500 of the imaging apparatus 1000, and the first accessory receives an upward supporting force from the imaging apparatus 1000 (as indicated by the upward arrow on the top face 1500 in FIG. 9). The fastening member of the first accessory is inserted/fitted into the first interface 1310, 1410. When the first accessory is subjected to an upward force or moves upward due to motion inertia (moving upward away from the imaging apparatus 1000), the first portion of the sidewall of the first interface 1310 (recess) applies a downward force toward the fastening member, so that upward displacement of the first accessory is restricted. When the first accessory is subjected to a lateral force or is likely to rotate and displace due to motion inertia (rotational displacement along the periphery of the imaging apparatus 1000), the second and third portions of the sidewall of the first interface 1310 (recess) respectively apply a leftward force and a rightward force toward the fastening member, so that rotational displacement of the first accessory is restricted. In FIG. 9, arrows are schematically shown on multiple portions of the sidewall of the recess to indicate the force perpendicular to the sidewall. The forces of the second and third portions of the sidewall of the first interface 1310 are not shown, but should be imaginable based on the description herein. In addition, due to the displacement of the first accessory, the fastening member is subjected to normal pressure from multiple portions of the sidewall, so that friction is generated between multiple portions of the sidewall and the fastening member, and the friction prevents the fastening member from moving along the sidewall, thereby preventing the fastening member from easily disengaging from the recess.

In the present disclosure, the first accessory is in contact with and receives an upward supporting force from the top face 1500 (top side) of the imaging apparatus 1000 when mounted on the first end of the imaging apparatus 1000. The first accessory can also be in contact with and receive lateral supporting forces from the first side face 1300 and the second side face 1400. Therefore, the arrangement of the first interface is combined with the shape of the top (first end) of the imaging apparatus 1000. That is, the top face 1500 (top side), the first side face 1300, and the second side face 1400 of the imaging apparatus 1000 actually serve as supporting surfaces, and the displacement of the first accessory is restricted. The force applied by the first interface to the first accessory is a relatively small component of the resultant force received by the first accessory. For the restricted displacement mode of the first accessory, the first interface only needs to provide a small force to achieve firm mounting and connection of the first accessory.

The imaging apparatus 1000 is restricted by the upward supporting force of the top face 1500 and the lateral supporting forces of the first side face 1300 and the second side face 1400. When the first accessory is displaced away from the imaging apparatus 1000, due to the design structure of the sidewall of the recess being perpendicular to the first side face/second side face, the direction of the force generated by the displacement of the fastening member on the sidewall of the recess or the direction of the reaction force received from the sidewall is perpendicular to the sidewall. The direction of the force is perpendicular to the direction of displacement, which forms a locking force on the fastening member. Therefore, the design of the recess can achieve firm fixing and supporting of the first accessory through a small structure and force. In some implementations, the imaging apparatus 1000 is configured to provide the first interface 1310 on the first side face 1300, and the distance from the first interface to the top face 1500 (top side) is set such that the direction of displacement of the fastening member in the first interface 1310 caused by the displacement of the first accessory is substantially perpendicular to the direction of the sidewall of the first interface. It should be understood that this is only an example for describing the principle of the present disclosure. In some implementations, in the imaging apparatus 1000,the first interface 1410 can be provided on the second side face 1400 alone or simultaneously.

FIG. 9 schematically shows that when the first interface 1310 and 1410 are symmetrically arranged on the first side face 1300 and the second side face 1400, the bottom surfaces of the first interfaces 1310 and 1410 apply opposite forces toward the fastening member, thereby restricting the left and right displacement of the first accessory along the imaging apparatus 1000. Accordingly, the fixing effect is further improved. When the sidewall has an inclined angle, multiple portions of the sidewall can apply normal forces, the horizontal component of which is opposite to the direction of displacement of the fastening member, further improving the fixing effect. In addition, since the elastic deformation of the fastening member increases during displacement, the reaction force generated by the sidewall increases, and the resistance to the fastening member further increases.

In the present disclosure, the first interface 1310 or 1410 can also be a protrusion, for example, a protrusion extending vertically outward from the first side face 1300, which has a sidewall. For example, the protrusion is a tetrahedral block, and the sidewall has four portions. In contrast to the above recess implementation, in this case, the corresponding first accessory of the imaging apparatus 1000 has a recess, and the protrusion of the imaging apparatus 1000 enters the recess of the first accessory. In this implementation, the protrusion can achieve the same or similar effect as the above recess implementation, and the mechanical principle is similar, which will not be repeated here.

In one implementation, the first portion (located on the upper side) of the sidewall of the first interface 1310 includes a first stop, which protrudes downward from the first portion of the sidewall. During the process of mounting the first accessory to the first end of the imaging apparatus 1000, the fastening member of the first accessory deforms to pass over the first stop and enter the first interface 1310. The first stop can prevent the fastening member of the first accessory from coming off the first interface 1310. The size of the first interface 1310 or 1410 can be enlarged to accommodate more fastening members of different sizes (in other words, the fastening member does not have to fit the first interface well), and at the same time, the first stop can prevent the fastening member from coming off the first interface 1310, thereby improving reliability and compatibility. In other implementations of the present disclosure, the second portion (located on the left side) of the sidewall of the first interface 1310 includes a second stop. In another implementation, the third portion (located on the right side) of the sidewall of the first interface 1310 includes a third stop. In another implementation, the fourth portion (located on the lower side) of the sidewall of the first interface 1310 includes a fourth stop. In one implementation, the sidewall of the first interface 1310 includes one or more of the first stop, the second stop, the third stop, and the fourth stop. In one implementation, the sidewall of the first interface 1310 includes the above four stops (i.e., the first stop, the second stop, the third stop, and the fourth stop), and the four stops form a continuous structure, so the strength of such a stop structure is improved. In one implementation, the sidewall of the first interface 1310 includes the above four stops, and the four stops are not a continuous structure but are separated from each other, so that the deformation of each stop is greater and adaptability is improved.

In one implementation, the first portion of the sidewall of the first interface 1310, 1410 is inclined, for example, extending obliquely upward. In other words, the first portion of the sidewall forms an angle with the horizontal direction. When the fastening member of the first accessory enters the first interface, since the fastening member elastically deforms when entering the first interface, during the process of the fastening member sliding along the first portion of the sidewall into a deeper position of the first interface, the first portion of the sidewall allows the elastic deformation of the fastening member to decrease, that is, the fastening member returns to its original state. Due to the inclined arrangement of the first portion of the sidewall, during the process of the fastening member of the first accessory leaving the first interface 1310, the fastening member is elastically deformed by the inclined sidewall, the pressure between the fastening member and the sidewall increases, the friction increases, and the resistance to the displacement of the fastening member increases, so the limiting effect on the first accessory is further improved.

In one implementation, the first portion of the sidewall of the first interface is inclined, and the second and/or third and/or fourth portions of the sidewall of the first interface are also inclined. For example, in one implementation, the fourth portion (facing upward) of the sidewall is inclined downward, and when the fastening member of the first accessory enters the first interface, the fastening member only contacts the fourth portion (facing upward) of the sidewall due to size reasons and is subjected to upward pressure. In this case, during the process of the fastening member of the first accessory leaving the first interface, the fastening member is subjected to upward pressure, the friction increases, the resistance to the fastening member leaving increases, and the limiting effect on the first accessory is further improved.

In one implementation, in addition to the second interface 1610 on the bottom face 1600, the imaging apparatus 1000 includes two first interfaces 1310, 1410. That is, the first interface 1310 arranged on the first side face 1300 and the first interface 1410 arranged on the second side face 1400 (not shown in FIG. 1). In one implementation, the positions of the first interface 1310 on the first side face 1300 and the first interface 1410 on the second side face 1400 are symmetrical about the central axis of the imaging apparatus 1000. The symmetrical arrangement of the two first interfaces 1310 and 1410 is beneficial for the accurate positioning of the first accessory and the force balance after installation, thereby further improving stability and firmness. In one implementation, the imaging apparatus 1000 can include different types of first interface 1310 on the first side face 1300 and first interface 1410 on the second side face 1400. The first interface 1310 on the first side face 1300 can be a recess discussed in the above implementation, and the first interface 1410 on the second side face 1400 is another type of recess. More types of first interfaces will be described in subsequent implementations herein.

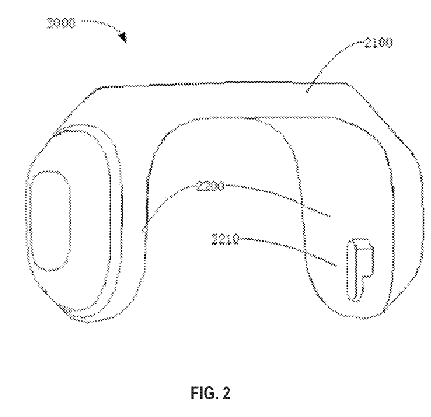

In one implementation, referring to FIGS. 2 to 4, in addition to the first interface 1310 and/or 1410, the imaging apparatus 1000 further includes at least one microphone hole 1320. Although one microphone hole 1320 is shown in the figure, two microphone holes 1320 may be respectively arranged on the first side face 1300 and the second side face 1400 of the imaging apparatus 1000. In this implementation, the first accessory can be a noise reduction element 2000. During operation of the imaging apparatus 1000, the noise reduction element 2000 can be mounted or connected to the first end of the imaging apparatus 1000, covering the microphone hole 1320. In this implementation, the noise reduction element 2000 includes: two first arms 2210, and a noise reduction arm fastening member 2210 connected between the two first arms 2210. The two first arms 2210 are respectively provided on their inner sides, i.e., the sides facing the first interface 1310, with noise reduction arm fastening members 2210 that cooperate with the first interfaces 1310, 1410. When the noise reduction element 2000 is fixed to the imaging apparatus 1000, the noise reduction arm fastening members 2210 snap into the first interfaces 1310, 1410. Since the noise reduction arm fastening members 2210 are received in the first interfaces 1310, 1410 and are restricted, the noise reduction element 2000 is firmly fitted to the first end of the imaging apparatus 1000. Even if the imaging apparatus 1000 is moved quickly or vibrated, the noise reduction element 2000 is not easily detached from the imaging apparatus 1000. In addition, since the noise reduction arm fastening members 2210 are received in the first interfaces 1310, 1410, the noise reduction element 2000 does not shift, so the fit between the noise reduction element 2000 and the imaging apparatus 1000 is tighter, and the interference of external airflow and noise with the microphone hole 1320 of the imaging apparatus 1000 is significantly reduced. According to the implementations of the present disclosure, the noise reduction element 2000 can have one noise reduction arm fastening member 2210 or two noise reduction arm fastening members 2210. The noise reduction arm fastening member 2210 can have a convex-concave fit relationship with the first interface 1310 and/or 1410. However, it should be understood that this is not necessary. The shape of the noise reduction arm fastening member 2210 does not have to be completely complementary to the first interface 1310. The shape of the first fastening member 2100 allows it to be received in the first interface 1310 to achieve the positioning and fixing effect of the noise reduction element 2000. In one implementation, the position of the first interface 1310 is below the microphone hole 1320. That is, the first interface 1310 is farther from the first end of the imaging apparatus 1000 than the microphone hole 1320. The first interface 1310 and the microphone hole 1320 can be located on the centerline of the first side face 1300.

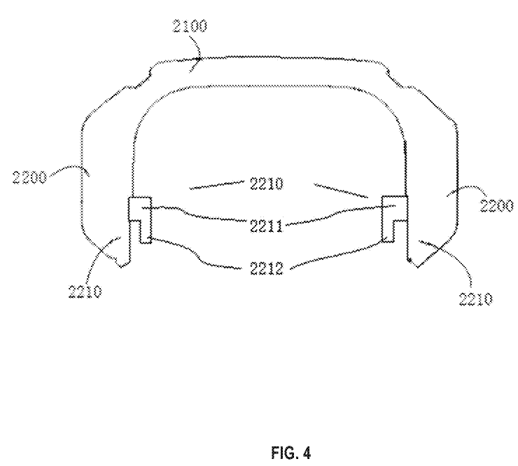

FIG. 2 shows a perspective schematic diagram of the noise reduction element 2000, and FIG. 4 shows a front schematic diagram of the noise reduction element 2000. The noise reduction element 2000 includes two noise reduction arms 2200 and a connecting portion 2100 connecting the two noise reduction arms 2200. A noise reduction arm fastening member 2210 is provided on the noise reduction arm 2200. In FIG. 2, a noise reduction arm fastening member 2210 is schematically shown on one noise reduction arm 2200 of the noise reduction element 2000. The noise reduction arm fastening member 2210 has a fastening member body 2211 and a fastening member tongue 2212 extending from the fastening member body 2211. The noise reduction arm fastening member 2210 is formed of a material such as silicone, so the fastening member tongue 2212 is elastic and has a high coefficient of friction.

In this implementation, when the noise reduction element 2000 is fitted onto the first end of the imaging apparatus 1000, the noise reduction arm fastening member 2210 snaps into the first interface 1310 of the imaging apparatus 1000. The fastening member tongue 2212 abuts against the fourth portion of the sidewall of the first interface 1310. The elastic fastening member tongue 2212 allows it to be received in the first interface 1310 in a deformed state and thus remain in the first interface 1310 in a deformed state. The friction between the fastening member tongue 2212 and the fourth portion of the sidewall of the first interface 1310 is further increased. In one implementation, the fourth portion of the sidewall of the first interface 1310 is provided with a recess. When the noise reduction arm fastening member 2210 with the fastening member tongue 2212 is inserted into the first interface 1310, the fastening member tongue 2212 can abut against the recess, thereby further increasing the resistance encountered by the fastening member tongue 2212 when leaving the first interface 1310. In this implementation, the imaging apparatus 1000 with the first interface 1310 and/or 1410 allows the noise reduction element 2000 to be easily fitted and blindly installed without distinguishing orientation, making operation simple. Furthermore, a firm connection between the noise reduction element 2000 and the imaging apparatus 1000 can be achieved. Even when the imaging apparatus 1000 is in motion, the noise reduction element 2000 will not fall off the imaging apparatus 1000, thereby effectively ensuring the good working state of the imaging apparatus 1000 and improving the user experience.

FIGS. 2-4 schematically show the noise reduction element 2000 as a shape similar to a head-mounted headset, however, the noise reduction element 2000 can have other shapes. It should be understood that the first interface 1310 and/or 1410 of the imaging apparatus 1000 of the present disclosure is also suitable for noise reduction elements 2000 of other shapes or forms.

In other implementations of the present disclosure, the first interface 1310 can also have other structures.

In the implementation where the first interface 1310 has the structure of a recess, a hole, or a notch, the first interface 1310 also has a magnetic material, which can be arranged at the bottom of the recess or hole, or on the sidewall. In one implementation, the first interface 1510 of the imaging apparatus 1000 is arranged on the top face 1500. The first accessory can be, for example, a lighting device. According to this implementation, the bottom of the lighting device has a supporting fastening member, which has a shape complementary to the first interface, and the supporting fastening member has a ferromagnetic material. In this implementation, the supporting fastening member of the lighting device can be directly inserted into the first interface 1510. Since the recess shape of the first interface 1510 is complementary to the supporting fastening member, the supporting fastening member can be easily inserted into the first interface 1510. At the same time, the magnetic material of the first interface 1510 is attracted to the ferromagnetic material of the supporting fastening member. When they contact, a “click” sound is made, so that the user can judge that the lighting device is installed in place. The strong magnetic attraction between the magnetic material of the first interface 1510 and the ferromagnetic material of the supporting fastening member can firmly mount the lighting device on the imaging apparatus 1000. In one implementation, the first interface and the supporting fastening member of the lighting device have a circular shape, and the supporting fastening member of the lighting device can rotate in the first interface to adjust the orientation of the lighting device. In another implementation, the first interface and the supporting fastening member of the lighting device have a non-circular shape, and the orientation of the lighting device is fixed. When the user installs the lighting device in the first interface, the user can automatically determine the front and rear orientation of the lighting device according to whether it is installed in place.

In this implementation, the imaging apparatus 1000 with the first interface 1510 allows for quick-release mounting and removal of the lighting device, and easy expansion of the external lighting device. This broadens the application scenarios of the imaging apparatus 1000, such as night capturing activities, while eliminating the need for users to carry or equip additional mounting equipment or to hold the lighting device by hand. Accordingly, the user experience is improved.

In one implementation, the imaging apparatus 1000 with the first interface 1510 allows a small radio or sound playback device to be connected to the first end of the imaging apparatus 1000, allowing the user to listen to music or provide external broadcasting during capturing. Due to the arrangement of the first interface 1510, devices such as lighting devices, radios, and sound playback devices can be quickly connected and disconnected to the imaging apparatus 1000. This ensures simple and easy operation, while preventing undesirable experiences such as falling off or shifting during operation. The first interface 1310 or 1510 has the shape of the recess in the above implementation. That is, the sidewall of the first interface 1310 or 1510 includes four portions, and the four portions of the sidewall respectively provide upward, downward, leftward, and rightward forces, thereby restricting the displacement of the fastening member fitted therein in four directions. The fastening member is fitted inside the first interface and will not rotate or shift. The first interface combined with the magnetic material can further provide a force in the normal direction of the above four directions of the first interface, further improving the connection with the first accessory and expanding the application of the first accessory.

In one implementation of the present disclosure, the first interface with magnetic material can be a protrusion, which can be easily conceived by referring to the above recess implementation.

The first interface can also be a magnetic sensing member mounted on the first side face 1300 or the second side face 1400 of the imaging apparatus 1000.

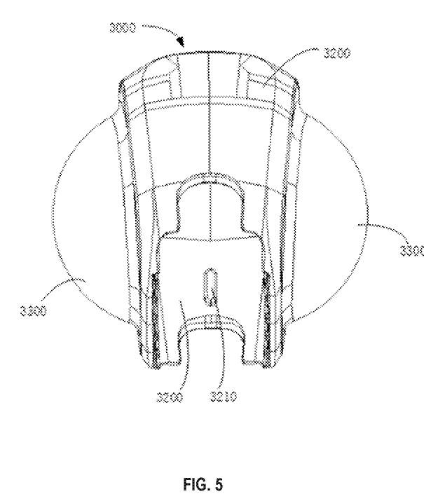

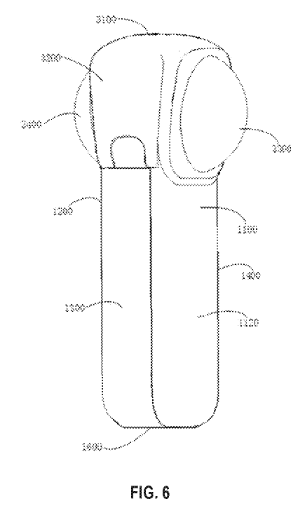

As shown in FIGS. 5-7, the first accessory is a protective element 3000, which can be fitted onto the first end of the imaging apparatus 1000. FIG. 5 shows a schematic perspective view of the protective element 3000, and FIG. 6 schematically shows the state of the protective element 3000 fitted onto the first end of the imaging apparatus 1000. The protective element 3000 includes: two protective element arms 3200, a protective connecting portion 3100 connecting the two protective element arms 3200, and protruding protective portions 3300 and 3400 located between the two protective element arms 3200.

In this implementation, the protective element 3000 includes a protective element fastening member 3210, and the protective element fastening member 3210 is provided with a magnetic material or sensing member. When the protective element 3000 is mounted on the imaging apparatus 1000, the magnetic sensing member of the protective element fastening member 3210 and the paired magnetic sensing member of the first interface 1310 generate a change in magnetic force and/or magnetic field (for example, a change in the magnitude and direction of the magnetic force and/or magnetic field), so that the protective element 3000 is recognized, and the sleep mode of the imaging apparatus 1000 is automatically triggered. When the protective element 3000 is removed from the imaging apparatus 1000, the removal of the protective element 3000 is recognized based on the change (disappearance) of the magnetic force and/or magnetic field generated between the magnetic sensing member of the protective element fastening member 3210 and the paired magnetic sensing member of the first interface 1310, and the capturing mode of the imaging apparatus 1000 is automatically triggered. This greatly promotes the automation and intelligence level of the imaging apparatus 1000 and improves the user experience. In this implementation, the first interface 1310 can be of any shape, and the first interface 1310 only needs to trigger the start-up or standby of the imaging apparatus 1000 through the magnetic sensing effect. However, the first interface 1310 of this implementation can also have the shape of a recess or protrusion in the above implementation, providing mechanical fixing while realizing the magnetic sensing function.

In another implementation, the first accessory is a lighting device. When the lighting device is mounted on the first end of the imaging apparatus 1000, the supporting fastening member of the lighting device engages the first interface 1510 (protrusion) on the top face 1500 of the imaging apparatus 1000. The protruding magnetic sensing member is attracted by the magnetic material or sensing member on the supporting fastening member of the first accessory, thereby triggering, for example, the power-on action of the imaging apparatus 1000. For example, when the imaging apparatus 1000 is in standby and the lighting device is mounted on the first interface, the supporting fastening member of the lighting device is inserted into the first interface. The magnetic sensing member of the first interface is attracted by the magnetic material or sensing member of the supporting fastening member of the lighting device, triggering the imaging apparatus 1000 to power on, so that the installation of the lighting device and the automatic power-on capturing of the imaging apparatus 1000 are achieved with one action of the supporting fastening member of the lighting device being received by the first interface.

The present disclosure also includes various implementations. For the above-described first interface, the imaging apparatus 1000 can include the first interface 1310 on the first side face 1300 and the first interface 1410 on the second side face 1400. Shapes and structures of the first interfaces 1310 and 1410 are completely the same. In another implementation, the first interface 1310 on the first side face 1300 and the first interface 1410 on the second side face 1400 are symmetrical about the central axis of the imaging apparatus 1000. Such a configuration can obtain a symmetrical and balanced force, further improving the stability of installation. In another implementation, the first interface 1310 on the first side face 1300 and the first interface 1410 on the second side face 1400 are only symmetrically arranged in position, but the structures of the first interface 1310 and 1410 are different. For example, the first interface 1310 on the first side face 1300 has an inclined sidewall or stop, while the first interface 1410 on the second side face 1400 does not have an inclined sidewall. Such an arrangement can realize the identification of the installation of the first accessory, so that the memory effect is obtained only when the first accessory is correctly installed. In another implementation, the positions of the first interfaces can be asymmetrical.

In one implementation, two or more first interfaces are provided on the first side face 1300 of the imaging apparatus 1000. In one implementation, two or more first interfaces are provided on the top face 1500 of the imaging apparatus 1000. Two or more first interfaces can be provided on one side face, as the lateral displacement of the first accessory on that side face is further stabilized. In some cases, multiple first accessories of different sizes can be mounted on the imaging apparatus 1000. Multiple first interfaces allow insertion options for fastening members of first accessories of different sizes.

One aspect of the present disclosure also provides an application system, including the disclosed imaging apparatus 1000. The system of the present disclosure is a user expansion system, which allows users to freely combine devices with different functions as needed to obtain a system with multiple functions. In one implementation, the application system includes the imaging apparatus 1000, an extension rod, and a lighting device. In the application system of this implementation, the imaging apparatus 1000 realizes capturing and provides connection functions. The second interface on the bottom face 1600 of the imaging apparatus 1000 is connected to the extension rod by, for example, threaded connection, buckle connection, or magnetic connection, while the first end of the imaging apparatus 1000 is mounted with a lighting device via the first interface 1510. The first interface 1510 of the imaging apparatus 1000 receives the supporting fastening member of the lighting device. Therefore, in the application system of the present disclosure, the imaging apparatus 1000 also serves as a connector or expansion port. The application system of this implementation can also include other accessories. By replacing the lighting device with a noise reduction element, the application system can capture images during movement. By replacing the protective element with a lighting device, the application system can start capturing and lighting in a dark environment. By replacing the noise reduction element with an external display screen or a mobile phone, capturing and navigation functions can be realized, etc.

So far, the implementations of the present disclosure have been described in detail with reference to the drawings. It should be noted that implementations not shown or described in the drawings or the text of the specification are all forms known to those skilled in the art and are not described in detail. In addition, the definitions of the above components are not limited to the various specific structures, shapes, or methods mentioned in the implementations. Those skilled in the art can make simple changes or replacements.

Those skilled in the art can understand that the features described in the various implementations and/or claims of the present disclosure can be combined and/or integrated in various ways, even if such combinations or integrations are not explicitly described in the present disclosure. In particular, without departing from the spirit and teachings of the present disclosure, the features described in the various implementations and/or claims of the present disclosure can be combined and/or integrated in various ways. All such combinations and/or integrations fall within the scope of the present disclosure.

The specific implementations described above further detail the objectives, technical solutions, and beneficial effects of the present disclosure. It should be understood that the above descriptions are only specific implementations of the present disclosure and are not intended to limit the present disclosure. Any modifications, equivalent replacements, improvements, etc., made within the spirit and principles of the present disclosure should be included within the protection scope of the present disclosure.

What is claimed is:

1. An imaging apparatus, comprising:
a first face;
a second face arranged parallel to the first face;
a first lens and a second lens, both arranged at a first end of the imaging apparatus, wherein the first lens is arranged on the first face and protrudes at least partially from the first face, and the second lens is arranged on the second face and protrudes at least partially from the second face;
a top face and a bottom face arranged opposite to one another and connecting the first face and the second face;
at least one first interface arranged on the top face, configured to mount a first accessory, the first interface being a recess; and
at least one second interface arranged on the bottom face, configured to mount a second accessory different from the first accessory, a connection of the second interface and the second accessory including at least one of threaded connection, buckle connection, snap connection, or magnetic connection.

2. The imaging apparatus according to claim 1, further comprising a display screen, arranged on at least one of the first face or the second face, and located at a second end of the imaging apparatus, wherein the second end is opposite to the first end.

3. The imaging apparatus according to claim 2, wherein geometric centers of the first lens and the second lens are located on a same projection path.

4. The imaging apparatus according to claim 2, wherein optical axes of the first lens and the second lens are located on a same straight line.

5. The imaging apparatus according to claim 2, wherein the first accessory is a lens protector, and the second accessory is at least one of a support base, a gimbal, a selfie stick, a tripod, or a stabilizer.

6. The imaging apparatus according to claim 2, wherein the at least one first interface is an elongated recess with arc-shaped ends.

7. The imaging apparatus according to claim 6, wherein the recess is rectangular.

8. The imaging apparatus according to claim 6, wherein a first portion of a sidewall of the at least one first interface is inclined at an angle with a horizontal direction.

9. The imaging apparatus according to claim 2, wherein a geometric center of the at least one first interface is substantially aligned with a geometric center of the first lens.

10. The imaging apparatus according to claim 9, wherein a fastening member of the first accessory is inserted into the at least one first interface, and when the first accessory is subjected to an upward force, a first portion of a sidewall of the at least one first interface applies a downward force towards the fastening member to restrict upward displacement of the first accessory.

11. The imaging apparatus according to claim 9, wherein a fastening member of the first accessory is inserted into the first interface, and when the first accessory is subjected to a lateral force, second and third portions of a sidewall of the at least one first interface apply a lateral force towards the fastening member to restrict rotational displacement of the first accessory.

12. The imaging apparatus according to claim 2, further comprising:
a first side face and a second side face, wherein the first side face and the second side face are arranged parallel to each other, and the top face and the bottom face are arranged parallel to each other.

13. The imaging apparatus according to claim 12, further comprising:
at least one microphone hole arranged on the first side face or the second side face of the imaging apparatus.

14. The imaging apparatus according to claim 2, wherein when the first accessory is mounted on the first interface, and configured to cover the first end of the imaging apparatus.

15. The imaging apparatus according to any of claim 1, wherein the first accessory comprises at least one of a protective element, a noise reduction element, a lighting device, a sound receiving device, a sound playback device, or a display device.

16. The imaging apparatus according to any of claim 1, wherein the second accessory comprises at least one of a selfie stick, a magnetic adapter, a tripod, a stabilizer, or a support base.
